(19) United States
(12) Patent Application Publication
(10) Pub. No.: US 2023/0172237 A1
(43) Pub. Date: Jun. 8, 2023

(54) STABLE PHYCOCYANIN BASED COLOR FORMULATION

(71) Applicant: OTERRA A/S, Hørsholm (DK)

(72) Inventors: Dina DIX, Milwaukee, WI (US); Adina JEROMINSKI, Milwaukee, WI (US); Lori NAPIER, Milwaukee, WI (US)

(73) Assignee: OTERRA A/S, Hørsholm (DK)

(21) Appl. No.: 17/797,516

(22) PCT Filed: Feb. 5, 2021
(86) PCT No.: PCT/EP2021/052845

§ 371 Date: Aug. 4, 2022

(30) Foreign Application Priority Data
Feb. 6, 2020 (EP) 20155882.2

(51) Int. Cl. A23L 5/46; A23L 29/219; A23L 29/00; A23G 3/48

(52) U.S. Cl. CPC A23L 5/46; A23L 29/219; A23L 29/03; A23G 3/48

(57) ABSTRACT

The present invention relates to a composition comprising a phycocyanin, glycerol and a modified starch. The present invention further relates to a method for preparing the composition and the use of the composition for coloring edible products.

The present invention relates to a coloring composition comprising the pigment phycocyanin. It further relates to a method for preparing the composition, the use of the composition for coloring food, feed, pet food, cosmetics, nutrients and pharmaceuticals and to blends with other pigments.

### BACKGROUND OF THE INVENTION

Phycocyanin is a pigment with a characteristic blue color. Phycocyanin is found in cyanobacterium also called blue-green algae. The blue phycocyanin pigment from cyanobacterium is often referred to as spirulina.

Phycocyanin is commonly isolated from spirulina algae and shows many dietary and therapeutic attributes. Therefore, spirulina and spirulina extracts have been used for many years as food or nutritional components. Phycocyanins are known to be very sensitive to temperature and pH changes in the environment, Seo et al., Int. J. Mol. Sci. 2013, 14, 1778-1787. Thus, there have been several attempts to stabilize phycocyanins for coloring purposes. WO15090697 describes the stabilization of phycocyanobilin with a polyphenol to obtain a stabilized complex by cleaving the phycocyanin either chemically or enzymatically and reacting with the polyphenol. WO18134390 describes a composition comprising phycocyanin, glycerol and an emulsifier which avoids foam when prepared and prevents microbial growth in the liquid. In Food Hydrocolloids, January 2018 74:46-52, Selig et al. describes the enhancement of color stability of spirulina based phycocyanin via a polysaccharide complex.

Despite these attempts to find a good solution, the problem still exists and there is still a need to find a suitable solution for stabilizing phycocyanins for use as colorants in especially food applications and especially where heat treatment is involved during production of the food.

### SUMMARY OF THE INVENTION

It is therefore the aim of the present invention to provide a stabilized phycocyanin coloring composition and said stabilized composition comprises a phycocyanin, glycerol and modified starch.

Accordingly, a first aspect of the present invention relates to a composition comprising a phycocyanin, glycerol and a modified starch.

A second aspect of the present invention relates to a process for the preparation of the composition according to the first aspect, comprising the steps of:
a) Mixing heated water and modified starch;
b) Adding glycerol;
c) Adding spirulina extract;
d) Optionally adding more glycerol; and
e) Optionally adjusting pH with acid.

A third aspect of the present invention relates to a method of coloring an edible product with the composition of the first aspect.

A fourth aspect of the present invention is directed to a food product, an animal feed, a pet food, a pet treat, a cosmetic, a nutrient and/or a pharmaceutical product comprising the composition according to the first aspect of the present invention.

A fifth aspect of the present invention relates to the use of the composition according to the first aspect of the present invention as a colorant for food, animal feed, pet food, pet treats, cosmetics, nutrients and/or pharmaceuticals.

### DETAILED DESCRIPTION OF THE INVENTION

The object of the present invention is to provide a heat and acid stable spirulina extract formulation for coloring food, feed, pet food, pet treats, cosmetics, hygienic products, nutrients products and/or pharmaceuticals. The problem is solved by a combination of spirulina extract, glycerol and a modified starch which provides a heat and acid stable formulation.

The problem is also solved by a method for preparing the composition of the present invention comprising dissolving spirulina extract and the modified starch in glycerol and optionally water.

The problem of the present invention is further solved by the use of the composition of the present invention as colorant, food colorant or coloring foodstuff.

The particular combination of glycerol and modified starch have shown a particularly good stabilizing effect on phycocyanin in applications.

Many pigments are used widely in the food industry such as carotenoids which are well know pigments in food applications but contrary to carotenoids which are not heat sensitive, spirulina extract is known to be sensitive to heat processing, and it has limited its use in food products processed at high temperatures as it present a challenge. Temperatures above 90° C. (194° F.) will denature the protein in spirulina extract, which is structurally bound to the pigment. When exposed to these thermal processes, the food product will show significant specking of the spirulina pigment. This is, in this application, illustrated in the process of producing hard candy, as it is commonly seen in applications such as hard boiled confectionaries, which is typically heat processed at temperatures between 115 and 160° C. (239 and 320° F.). If a food application is heat processed and has a pH below 4, not only will specking of the spirulina pigment be apparent but the shade will also shift from a bright blue to a more greenish blue hue. This can be seen in for example acidic sugar based hard boiled candy applications, where high temperature and high acid addition is common. Standard spirulina formulations containing water, when used in hard candy applications will give significant specking throughout the hard boiled candy and with the spirulina pigment shifting from blue to a green blue shade. The inventors have found that the formulations of the invention reduced the specking of the spirulina pigment considerably compared to a standard liquid spirulina formulation. The present invention allows for a transparent blue color in e.g. hard candy matrix while maintaining its bright blue shade, compared to the hazy greenish blue shade known before.

The advantages of the present invention are that the spirulina formulations are heat stable and acid stable, and they do not precipitate, agglomerate or flocculate when used as colorants in food applications. It does not fade in color or aggregate when heated in neutral or acidic applications. The present invention brings a vivid color, transparency and clarity to the product e.g. candy without particulates or cloudiness. The formulation has proven to be particularly good in the applications of confectionary e.g. hard boiled candy and jelly gums.

According to the present invention the term “stable” refers to a composition which easily incorporates into the product, e.g. a candy matrix, without causing undesirable effects such as shift in shade, agglomeration with particulates being formed, precipitation, flocculation or cloudiness.

Spirulina Extract

Spirulina extract is obtained by aqueous extraction of the biomass of Arthrospira platensis, an edible cyanobacterium. Commercial products are formulated into liquid and powder forms. Spirulina extract is a blue coloring agent used in a wide range of foods and beverages including flavored dairy products, cheese, dairy based desserts, processed fruits and vegetables, baked good and baking mixes, alcoholic and non-alcoholic beverages and beverage bases, breakfast cereals, cocoa products, confectionery products (including soft and hard candy and chewing gum), egg products, gravies and sauces, herbs and spices, condiments and soup and soup mixes, as well as in nutritional supplements and pharmaceuticals. The main coloring pigment in the spirulina extract is phycocyanin.

Spirulina extract can contain other ingredients to stabilize the color, including but not limited to trehalose, other sugars, trisodium citrate, algae biomass and maltodextrin. In a particular embodiment of the present invention the spirulina extract is trehalose free.

In Europe, spirulina extract is known as a coloring foods rather than an additive food color. A coloring foods (coloring foodstuff) is a food ingredient used for coloring purposes. In a particular embodiment the composition is a coloring foods.

Normally such spirulina extract is comprising at least 2% (w/w), such as at least 5% (w/w), such as at least 7% (w/w), such as at least 10% (w/w) such as at least 15% (w/w), such as at 20% (w/w), such as at least 25% (w/w) of phycocyanin. In a particular embodiment of the present invention the amount of phycocyanin present in the composition of the present invention is between 0.1 to 20% (w/w), such as between 0.3 to 15% (w/w), such as between 0.5 to 12% (w/w), such as between 0.7 to 10% (w/w), such as between 1 to 8% (w/w), such as between 1.5 to 5% (w/w).

In a preferred embodiment of the present invention the amount of spirulina extract present in the composition is at least 2% (w/w), such as at least 5% (w/w), such as at least 7% (w/w), such as at least 2% (w/w), such as at least 10% (w/w), such as at least 15% (w/w), such as least 20% (w/w), such as least 25% (w/w).

In a preferred embodiment of the present invention the amount of spirulina extract present in the composition is less than 95% (w/w), such as less than 85% (w/w), such as less than 750% (w/w) such as less than 65% (w/w), such as less than 60% (w/w), such as less than 55% (w/w), such as less than 40% (w/w), such as less than 35% (w/w.

In a preferred embodiment of the present invention the spirulina extract comprising phycocyanin is food grade. The spirulina extract may be a powder or a liquid. In a particular embodiment of the present invention the spirulina extract is a powder.

The spirulina extract is added as a colorant or nutrient.

Glycerol

The inventive composition comprises glycerol.

In a preferred embodiment of the present invention the amount of glycerol present in the composition is at least 30% (w/w), such as at least 35% (w/w), such as at least 40% (w/w), such as at least 45 (w/w), such as at least 50% (w/w), such as at least 52% (w/w).

In a preferred embodiment of the present invention the amount of glycerol present in the composition is less than 85 (w/w), such as less than 80% (w/w), such as less than 75% (w/w), such as less than 70% (w/w) such as less than 65% (w/w), such as less than 60% (w/w), such as less than 58% (w/w).

In a particular embodiment of the present invention the amount of glycerol present in the composition is between 30 to 85% (w/w), such as between 35 to 75% (w/w), such as between 40 to 70% (w/w), such as between 45 to 65% (w/w), such as between 50 to 60% (w/w).

In a preferred embodiment of the present invention the glycerol is food grade.

Modified Starch

The inventive composition comprises a modified starch.

In a particular embodiment the modified starch is a starch octenyl succinate derivative (OS starch). OS starch has amphiphilic properties due to the esterification of a hydrophobic fatty acid chain onto a hydrophilic starch backbone.

The starch backbone can be any commercially available starch comprised of between 20 to 100% amylopectin, preferably 100% amylopectin. OS starch is produced by treating starch with n-octenyl succinic anhydride and has a degree of substitution (D.S.) up to 0.11, more preferably up to 0.03 are used within the present invention. The OS starch can be cook-up or instantized, with alterations in processing. Alternatively, the molecular weight of the starch may be manipulated by acid hydrolysis, as this will impact overall viscosity of the color formulation assisting in optimum functionality in the final application.

In a preferred embodiment the modified starch is starch sodium octenyl succinate having the E-number E1450.

In a preferred embodiment of the present invention the modified starch e.g. starch sodium octenyl succinate is food grade.

In a preferred embodiment of the present invention the amount of modified starch e.g. starch sodium octenyl succinate is present in the composition is at least 0.5% (w/w), such as at least 0.7% (w/w), such as at least 1% (w/w), such as at least 1.5 (w/w), such as at least 2% (w/w), such as at least 3% (w/w), such as least 4% (w/w), such as least 5% (w/w), such as at least 6% (w/w).

In a preferred embodiment of the present invention the amount of modified starch e.g. starch sodium octenyl succinate present in the composition is less than 30% (w/w), such as less than 28% (w/w), such as less than 26% (w/w) such as less than 25% (w/w), such as less than 23% (w/w), such as less than 20% (w/w), such as less than 18% (w/w), such as less than 16% (w/w), such as less than 15% (w/w), such as less than 12% (w/w), such as less than 10% (w/w).

In a preferred embodiment of the present invention the amount of modified starch e.g. starch sodium octenyl succinate present in the composition is between 0.5 to 30% (w/w), such as between 1 to 20% (w/w), such as between 2 to 15% (w/w), such as between 4 to 12% (w/w), such as between 6 to 10%

In a preferred embodiment of the present invention the composition comprises from 4% to 50% of the modified starch e.g. starch sodium octenyl succinate, more preferably it comprises from 4% to 30% of the modified starch e.g. starch sodium octenyl succinate.

In a suitable example it comprises from 7% to 25% of modified starch e.g. starch sodium octenyl succinate.

The composition of the present invention may further comprise at least one further component. Such components may include but are not limited to: water, carrier, antifoam, acid, emulsifier, and plasticizing agents.

Water

In a particular embodiment water is added to the formulation.

The modified starch and spirulina may be dissolved in pure glycerol, however it foams significantly and takes a long duration for the spirulina and modified starch to dissolve. To decrease the time for dissolving the modified starch and the spirulina, water may be added. In a particular embodiment of the present invention water is added in an amount of at least 5%, such as at least 7%, such as at least 10%, such as at least 12%, such as at least 15%, such as at least 18%, such as at least 20%, such as at least 22%, such as at least 25%. In a particular embodiment of the present invention water is added in an amount of less than 45%, such as at least 40%, such as at least 35%, such as at least 30%, such as at least 28%, such as at least 25%. In a particular embodiment of the present invention the formulation comprises 10 to 30%, such as 12 to 28%, such as 15 to 25%.

In a preferred embodiment in combination with any of the above or below embodiments the composition of the present invention comprise water.

Antifoam

Besides water adding antifoam may help the foaming issue.

In a particular embodiment of the present invention an antifoam agent is added. The antifoam agent is preferably a silicone oil based antifoam.

In a preferred embodiment in combination with any of the above or below embodiments the composition comprise antifoam.

Acid

In a preferred embodiment in combination with any of the above or below embodiments the composition comprise acid.

Suitable acids for acidifying the solution include citric acid, lactic acid, malic acid, acetic acid, hydrochloric acid, sulphuric acid and phosphoric acid. In a particular embodiment of the present invention the pH is adjusted to between 3.5 to 6.5 such as between 4.5 to 5.5.

Emulsifier

The present formulation may also comprise an emulsifier

In a particular embodiment of the present invention the composition comprises an emulsifier selected from the group consisting of lecithins, mono- and/or diglycerides of fatty acids, polyglycerol esters of fatty acids, or mixtures thereof. More preferably, the emulsifier is mono- and/or diglyceride of fatty acids or lecithin, in particular, lecithin.

Commercially available lecithins are usually lecithin extracts diluted in natural oils composed of triglycerides, e.g. soy oil or sunflower oil. Glycerol phospholipids in lecithin include phosphatidylcholine, phosphatidylethanolamine, phosphatidylinositol, phosphatidylserine, and phosphatidic acid. Lecithins are used as food additives and are designated as E322, E322 further includes hydrolyzed lecithins, wherein one fatty acid is removed from the glycerophospholipids enzymatically. Thus, the resulting lysolecithins are composed mainly of lysophosphatidylcholine, lysophosphatidylethanolamine, lysophosphatidylinositol, and lysophosphatidylserine.

Further the composition may comprise a carrier such as trisodium citrate or polysaccherides. Further, the composition of the present invention may comprise one or more carbohydrates or sugar alcohols or a mixture thereof. The carbohydrate is preferably selected from the group consisting of a monosaccharide, a disaccharide and an oligosaccharide such as trehalose, maltodextrin, glucose, lactose, fructose and sucrose. The sugar alcohol can e.g. be selected from the group consisting of sorbitol, mannitol, dulcitol and adonitol.

In a preferred embodiment in combination with any of the above or below embodiments, the liquid composition according to the present invention has a viscosity of not more than 160 cP at 20° C., more preferably not more than 100 cP at 20° C. The viscosity is determined with a classical rotational viscosimeter Brookfield DV-II+ Pro Programmable Viscometer using a LV-3 spindle (30 rpm in a 100 mL sample vessel).

There are several ways to classify the color of a substance. Generally, the color characteristics of a substance may be characterized by three parameters, the hue, the saturation and the lightness.

Hue is an attribute associated with each of the dominant wavelengths of the visible spectrum and reflects the dominant color of the composition (red, yellow, blue etc.). Saturation, also referred to as Chroma, pertains to the intensity of the color composition often described as the vividness or the dullness of a color. Lightness reflects the amount of white or black in the color composition. In a particular embodiment of the present invention color is measured by the use of a spectrophotometer or a similar instrument capable of taking readings on hue, chroma and lightness in accordance with CIE (Commission Internationale de L'Eclairage—the International Commission of Illumination) tristimulus system: CIELCH. In the CIELCH system, L* denotes lightness, C* specifies chroma and h denotes the hue.

The composition of the present invention is particularly useful as a colorant. In a particular embodiment the composition has a blue color defined by a hue value between 200° and 280°, such as between 220° and 250° when measured with a spectrophotometer such as a Konica Minolta CM-3700d. The composition may be used in blends with other pigments, such as carotenoids, and especially with β-carotene, curcumin or carthamus to form green colors, and with anthocyanins or betalains to form purple colors.

In a particular embodiment the invention covers blends of the present composition with other pigments, said blend having a purple color defined by a hue value of 240° to 300° when measured on a spectrophotometer such as a Konica Minolta CM-3700d.

In another particular embodiment the invention covers blends of the present composition with a carotenoid resulting in a green color defined by a hue value of 140° to 200° when measured on a spectrophotometer such as a Konica Minolta CM-3700d.

In a particular embodiment the composition of the present invention is a coloring composition. In another particular embodiment the composition is a liquid composition. In a further particular embodiment the composition does not comprise microcapsules.

Preparation Method

The present invention is further related to a process of preparing a composition of the present invention.

In a particular embodiment of the present invention the process for preparation of the composition of the present invention, comprises the steps of:
a) Mixing heated water, modified starch and optionally antifoam;
b) Adding glycerol;
c) Adding spirulina extract;
d) Optionally adding more glycerol; and
e) Optionally adjusting pH with acid.

To avoid foaming it is recommended to add antifoam together with the water.

In a particular embodiment the water is heated to at least 50° C. such as to at least 55° C. such as to at least 60° C. before adding the modified starch. After adding glycerol the formulation should be cooled to below 45° C., such as to below 40° C. before the spirulina extract is added. After adding the Spirulina the formulation is mixed until all spirulina is dissolved. If not all glycerol has been added in the first step the rest of the glycerol is now added and pH adjusted with a suitable acid e.g. citric or sulfuric acid. Preferably the pH is adjusted to 3.5 to 6.5, preferably to 4 to 6 such as to 4.5 to 5.5. It has been found that the composition is particularly stable when the pH is in the range of 4 to 6 such as 4.5 to 5.5.

In a more particular embodiment of the present invention the process for preparation of the composition of the present invention, comprises the steps of:
a) Heating water to at least 50° C.;
b) Mixing the heated water of a) and modified starch and optionally antifoam;
c) Adding glycerol and cooling to below 45° C.;
d) Adding spirulina extract and mixing;
e) Adding more glycerol; and
f) Adjusting pH with acid.

The composition of the present invention may find use as colorant for products such as food products, animal feeds, pet food, pet treats, cosmetics, nutrients and pharmaceutical products.

In a particular embodiment the food product is selected from the group consisting of a beverage such as soft drinks, flavored water, fruit juices, punches, concentrated forms of these beverages but also alcoholic beverages and instant beverage powders, confectionary products, wine gum, cake, cookies, dessert, candies, puddings, jellies, instant pudding powder, marmalade, jam, sugar confectionary, panned chocolate lentils, ice cream, cereals, but also in snacks, sausage casings, pasta, macaroni, cheese, milk drinks or yoghurt, soy milk, salad dressing, soups, sauces, dairy fruit prep, prepared food and/or extruded food.

In one embodiment cosmetic preparations are selected from cream, tooth paste, makeup and dermal products.

In a preferred embodiment the composition of the present invention is used for coloring confectionary, such as hard candy and soft candy such as jelly gums. The present invention may be used in both sugar based and sugar free candy. The candy may comprise but are not limited to isomalt, sugar alcohols e.g. erythitol and sorbitol.

In a particular embodiment of the present invention the invention is used in hard candy as a blue colorant.

In a further embodiment, pharmaceutical preparations are selected from unguents, pills, tablets and capsules.

The coloring composition of the present invention may be added to the product either as an aqueous stock solution or a pre-blend with other suitable ingredients according to the specific application

The coloring composition is particularly useful in low pH applications such as in application where pH of the product is below 7, such as below 6, such as below 5, such as below 4, or even below a pH of 3.

The following items are preferred embodiments of the present invention:

Item 1. A composition comprising glycerol, modified starch and a spirulina extract comprising phycocyanin.

Item 2. The composition of item 1, wherein the spirulina extract is derived from Arthrospira platensis.

Item 3. The composition according to any of the preceding items, wherein the composition is a heat stable composition.

Item 4. The composition according to any of the preceding items, wherein the composition does not form specks when added to a hard candy composition having a temperature above 90° C., such as above 100° C., such as above 110° C., such as above 120° C., such as above 130° C.

Item 5. The composition according to any of the preceding items, wherein the composition is a coloring composition.

Item 6. The composition according to any of the preceding items, wherein the glycerol is present in an amount of at least 40% (w/w).

Item 7. The composition according to any of the preceding items, wherein
a) the spirulina extract is present in an amount of at least 2% (w/w),
b) the glycerol is present in an amount of at least 40% (w/w); and
c) the modified starch is present in an amount of at least 0.5% (w/w)

Item 8. The composition according to any of the preceding items, wherein the modified starch is starch sodium octenyl succinate.

Item 9. The composition according to any of the preceding items, wherein the composition further comprises at least one component selected from the group consisting of water, antifoam, acid and emulsifier.

Item 10. The composition according to any of the preceding items, wherein the water content is between 5 to 45%, such as 10 to 30%, such as 12 to 28%, such as 15 to 25% (w/w).

Item 11. The composition according to any preceding items, wherein the pH is between 3 to 6.

Item 12.The composition according to any of items 1 to 10, wherein the pH is between 4.5 to 5.5.

Item 13. The composition according to any of the preceding items, further comprising a second pigment selected from group consisting of carotenoids, carthamus, curcumin, anthocyanin, and betalains.

Item 14. The composition according to any of items 1 to 13, wherein the spirulina extract is trehalose free.

Item 15. A method for preparing a composition according to any of the items 1 to 14, comprising the steps of:
a) Mixing heated water, modified starch and optionally antifoam;
b) Adding glycerol;
c) Adding spirulina extract;
d) Optionally adding more glycerol; and
e) Optionally adjusting pH with acid.

Item 16. A method for preparing a composition according to any of the items 1 to 14, comprising the steps of:
a) Heating water to at least 50° C.;
b) Mixing the heated water of a) and modified starch and optionally antifoam;
c) Adding glycerol and cooling to below 45° C.;
d) Adding spirulina extract and mixing;
e) Adding more glycerol; and
f) Adjusting pH with acid.

Item 17. A method for coloring an edible product, wherein the composition of any of items 1 to 14 is incorporated into the edible product in order to add color to the edible product.

Item 18. An edible product comprising the composition according to any of the items 1 to 14 as a colorant.

Item 19. The edible product of item 18, wherein the edible product has been exposed to heat treatment.

Item 20. The edible product according to any of items 18 to 19, wherein the edible product is a confectionary. Item 21. The edible product of item 20, wherein the confectionary is hard boiled confectionery (hard candy), extruded licorice, soft and hard panned confectionery, aerated foam, jelly gum, chewing gum, and/or soft chews.

Item 22. A method for preparing the confectionary of item 20 comprising the steps of
a) Mixing any ingredients;
b) Heating the mixture of ingredients; and
c) Adding the composition of any of item 1 to 14 to the heated mixture.

Item 23. Use of a composition according to any of the items 1 to 14 for coloring an edible product.

Item 24. The use of item 18, wherein edible product is a beverage, a confectionary, ice cream, a dairy product, processed fruits and vegetables, baked good, breakfast cereal, cocoa product, egg product, nutritional supplement and/or a pharmaceutical product.

Item 25. The use of item 18, wherein the edible product is a confectionary and the confectionary is hard boiled confectionery, extruded licorice, soft and hard panned confectionery, aerated foam, jelly gum, chewing gum, and soft chews.

Item 26. The use of item 18, wherein the edible product is a nutritional supplement and/or a pharmaceutical product and are compressed tablet or pills, gummies, hard capsules, softgel capsules, gelatin capsules, lozenges, effervescent tablets, sachets with powder or granules to be rehydrated, liquid or pasty presentation.

The following examples further describes the present invention.

### EXAMPLES

Formulation ingredients

Spirulina Extract—contains spirulina extract, trehalose and trisodium citrate

Glycerol 99.7% (Archer Daniels Midland)

Citric acid anhydrous (Jungbunzlauer)

Water (Purified municipal water)

Antifoam—contains silicon oil, silica and potassium benzoate (Struktol)

Starch sodium octenyl succinate, Hi-Cap 100 (Ingredion, Inc.)

Mono and di-glycerides (Danisco)

Invert sugar 73% (Nordic sugar)

Potassium sorbate (APAC Chemical Corp)

Trisodium citrate (Elementar GmbH)

Preparation of Coloring Compositions

TABLE 1
Color compositions, foam evaluation and pH data.

| | Sample | | | | | | | |
|---|---|---|---|---|---|---|---|---|
| Ingredient | A | B | C | D | E | F | G | H |
| Spirulina extract | 5.00 | 14.00 | 10.00 | 20.00 | 15.00 | 8.00 | 15.00 | 8.00 |
| Glycerol | 95.00 | | 67.05 | 50.00 | 49.02 | 68.10 | 64.90 | 65.10 |
| Invert sugar 73% | | 63.30 | | | | | | |
| Water | | 20.00 | 22.50 | 29.20 | 15.00 | 18.50 | 17.50 | 18.50 |
| Citric acid | | 0.20 | 0.20 | 0.40 | 0.22 | 0.20 | 0.40 | 0.20 |
| Antifoam | | 0.50 | 0.25 | 0.20 | 0.20 | 0.20 | 0.20 | 0.20 |
| Potassium sorbate | | | | 0.20 | | | | |
| Trisodium citrate | | | | | 0.56 | | | |
| Modified starch | | | | | | | 2.00 | 8.00 |
| Mono and di-glycerides | | | | | | 5.00 | | |
| Foam | Yes | No | No | No | No | No | No | No |
| pH | 5.97 | 4.91 | 5.13 | 5.10 | 5.80 | 4.84 | 5.05 | 4.99 |

Sample A

Glycerol was added to a stainless steel beaker. Agitation was initiated at 200 rpm's. Spirulina extract was incorporated slowly. The spirulina extract addition occurred over a thirty minute time frame. The mixture was allowed to mix for a twenty four hour period to ensure full incorporation of the spirulina extract.

The extended blending produced high viscosity through air incorporation. Blend contained a significant amount of foam. Small scale benchtop (i.e. 100 g) can slowly be incorporated with low air incorporation but not feasible to scale up.

Sample B

Water was added to a stainless steel beaker. Agitation was initiated at 300 rpm's. Antifoam was added to the water and allowed to mix for approximately ten minutes. Spirulina extract was incorporated slowly. The spirulina extract addition occurred over a thirty minute time frame. The mixture was allowed to mix for approximately a thirty minute period to ensure full incorporation of the spirulina extract.

Invert sugar was then added to the mixture and agitation speed was increased to 400 rpm's. Citric acid was added to mixture.

The mixture was allowed to mix for one hour.

Sample C

Water was added to a stainless steel beaker. Agitation was initiated at 300 rpm's. Antifoam was added to the water and allowed to blend for approximately ten minutes. 25% of the glycerol was added to the mixture and allowed to mix for ten minutes. Spirulina extract was incorporated slowly. The spirulina extract addition occurred over a thirty minute time frame. Citric acid was added to the mixture. Agitation was increased to 450 rpm's and allowed to mix for thirty minutes. Remaining glycerol was added to the mixture and mixed an additional thirty minutes. Blend was quite viscous.

Sample D

Water was added to a stainless steel beaker. Agitation was initiated at 300 rpm's. Potassium sorbate is added and allowed to dissolve. Antifoam was added and allowed to mix for approximately ten minutes. 25% of the glycerol was added to the mixture and allowed mix for ten minutes. Spirulina extract was incorporated slowly. The spirulina extract addition occurred over a thirty minute time frame. Agitation was increased to 450 rpm's and allowed to mix for thirty minutes. Remaining glycerol was added to the mixture and mixed an additional thirty minutes. Citric acid was added to the mixture and allowed to mix for ten minutes.

Sample E

Water was added to a stainless steel beaker. 30% of Glycerol was added to the water. Agitation was initiated at 300 rpm's. Citric acid was added mixture. Trisodium citrate was added mixture. Antifoam was added to the mixture. Mixture was allowed to mix twenty minutes to fully dissolve the citric acid and trisodium citrate

Spirulina extract was incorporated slowly. The spirulina extract addition occurred over a thirty minute time frame. Agitation was increased to 450 rpm's and allowed to mix for thirty minutes. Remaining glycerol was added to the mixture and mixed an additional thirty minutes

Sample F

Water was added to a stainless steel beaker. Antifoam was added to the mixture. Agitation was initiated at 300 rpm's. Mono and di-glycerides was added to the mixture and 18% of Glycerol was added to the mixture

Spirulina extract was incorporated slowly. The spirulina extract addition occurred over a thirty minute time frame. Agitation was increased to 450 rpm's and allowed to mix for thirty minutes. Remaining glycerol was added to the mixture and mixed an additional thirty minutes. Citric acid was added to mixture and mixed for ten minutes. Blend was quite viscous.

Example G

Water was added to a stainless steel beaker. 15% of Glycerol was added to the water. Antifoam was added to the mixture and agitation was initiated at 300 rpm's. Mixture was heated to 50° C. Modified starch was added to mixture and mixed thirty minutes. Temperature of the mixture was decreased to 40° C. Spirulina extract was incorporated slowly. The spirulina extract addition occurred over a thirty minute time frame. Agitation was increased to 450 rpm's and allowed to mix for thirty minutes. Remaining glycerol was added to the mixture and mixed an additional thirty minutes. Citric acid was added to mixture and mixed for ten minutes.

Example H

Water was added to a stainless steel beaker. Antifoam was added to the mixture. 15% of Glycerol was added to the water. Agitation was initiated at 300 rpm's. Mixture was heated to 50° C. Modified starch was added to mixture and mixed thirty minutes. Temperature of the mixture was decreased to 40° C. Spirulina extract was incorporated slowly. The spirulina extract addition occurred over a thirty minute time frame. Agitation was increased to 450 rpm's and allowed to mix for thirty minutes. Remaining glycerol was added to the mixture and mixed an additional thirty minutes. Citric acid was added to mixture and mixed for ten minutes

The color data L*, C* and h° were measured on all the samples A to H, see table 2.

TABLE 2
Colorimetric data for the color compositions.

| | Sample | | | | | | | |
|---|---|---|---|---|---|---|---|---|
| | A | B | C | D | E | F | G | H |
| L* | 75.79 | 73.79 | 65.55 | 71.98 | 65.88 | 72.01 | 72.50 | 71.36 |
| C* | 12.66 | 13.67 | 23.46 | 15.10 | 22.47 | 16.42 | 15.25 | 16.71 |
| h° | 221.53 | 223.03 | 239.41 | 227.82 | 238.38 | 226.74 | 227.73 | 227.35 |

Preparation of Hard Candy

Ingredients:

Isomalt 300 g

Purified Tap water 100 g

Citric acid (50% solution) 6.0 g

Isomalt was mixed with water in an appropriate container and heated to 135° C. The 50% citric acid solution was added to the container and the mixture was then heated to 165° C. The candy mass was cooled to 130° C.

The color formulation was added to the container and gently stirred until a homogeneous colored candy mass was achieved.

The candy mass was poured into the metal molds using a teaspoon. The poured candies were allowed to set and cool. Removing the candies from the molds for evaluation. See the results in table 3.

TABLE 3
Evaluation of the blue color in hard candy

| | Sample mixed with candy mass | | | | | | | |
|---|---|---|---|---|---|---|---|---|
| | A | B | C | D | E | F | G | H |
| Significant amount of | No | Yes | Yes | Yes | Yes | No | No | No |
| particulate (specks) in | | | | | | | | |
| the hard candy | | | | | | | | |
| Cloudiness in the hard | No | No | No | No | No | Yes | No | No |
| candy | | | | | | | | |

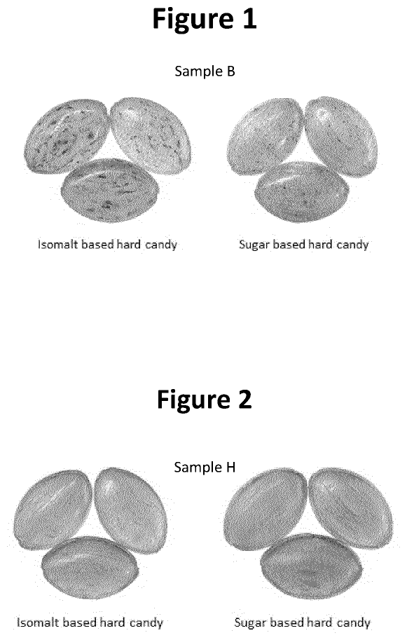

The result of Sample B in sugar and in isomalt candy can be seen in FIG. 1 and the result of sample H in sugar and in isomalt candy can be seen in FIG. 2. It can be seen from the figures that there are a lot of speck formation in sample B, whereas sample H is completely without specks.

### CONCLUSION

The formulation limited to spirulina extract and glycerol required extended blending to aid in the dissolution of the spirulina extract and produced viscosity through air incorporation. The addition of an antifoam agent decreased the occurrence of foam generation.

Adding water to the formulation together with glycerol significantly improved the dissolution of the spirulina extract and decreased viscosity and blending time. However, when adding water particulates were formed in the hard candy.

Mono and di-glycerides, invert sugar, potassium sorbate and trisodium citrate were evaluated in the formulation. The addition of these in formulation did not deter the formation of particulates.

The addition of modified starch vastly improved the performance of the formulation in the hard candy. The samples with modified starch demonstrated that a combination of modified starch and glycerol produced a formulation that provided protective properties for spirulina extract to produce clear, blue particulate (speck) free hard candies.

1. A coloring composition comprising glycerol, modified starch and a spirulina extract comprising phycocyaninfor use in an edible product, wherein the edible product has been exposed to heat treatment.

2. The composition of claim 1, wherein the spirulina extract is derived from Arthrospira platensis.

3. The composition of claim 1, wherein the composition is a heat stable composition.

4. (canceled)

5. The composition of claim 1, wherein the glycerol is present in an amount of at least 40% (w/w).

6. The composition of claim 1, wherein
a. the spirulina extract is present in an amount of at least 2% (w/w),
b. the glycerol is present in an amount of at least 40% (w/w); and
c. the modified starch is present in an amount of at least 0.5% (w/w)

7. The composition of claim 1, wherein the modified starch is starch sodium octenyl succinate.

8. The composition of claim 1, wherein the water content is between 5 to 45% (w/w).

9. The composition of claim 1, wherein the pH is between 3 to 6.

10. The composition of claim 1, wherein the pH is between 4.5 to 5.5.

11. The composition of claim 1, further comprising a second pigment selected from group consisting of carotenoids, carthamus, curcumin, anthocyanin, and betalains.

12. The composition of claim 1, wherein the composition does not form specks when added to a hard candy composition having a temperature above 90° C.

13. The composition of claim 1, wherein the spirulina extract is trehalose free.

14. A method for preparing a composition of claim 1,comprising the steps of:
a) Mixing heated water, modified starch and optionally antifoam;
b) Adding glycerol;
c) Adding spirulina extract;
d) Optionally adding more glycerol; and
e) Optionally adjusting pH with acid.

15-22. (canceled)

23. The use of claim 1, wherein the edible product is a confectionary and the confectionary is hard boiled confectionery, extruded licorice, soft and hard panned confectionery, aerated foam, jelly gum, chewing gum, and soft chews.

24. The use of claim 1, wherein the edible product is a nutritional supplement and/or a pharmaceutical product and are compressed tablet or pills, gummies, hard capsules, softgel capsules, gelatin capsules, lozenges, effervescent tablets, sachets with powder or granules to be rehydrated, liquid or pasty presentation.
